(19) United States
(12) Patent Application Publication
(10) Pub. No.: US 2018/0268679 A1
(43) Pub. Date: Sep. 20, 2018

(54) WEARABLE ALERT DEVICE AND METHOD

(71) Applicant: Carmen Shropshire, Baker, LA (US)

(72) Inventor: Carmen Shropshire, Baker, LA (US)

(21) Appl. No.: 15/922,892

(22) Filed: Mar. 15, 2018

Related U.S. Application Data
(60) Provisional application No. 62/472,476, filed on Mar. 16, 2017.

(51) Int. Cl. G08B 21/24; G08B 21/22; G08B 21/02

(52) U.S. Cl. CPC G08B 21/24; G08B 21/02; G08B 21/22

(57) ABSTRACT

A device for providing an alert to a user includes a housing, a display screen attached to the housing and configured to display a plurality of images, a band having a predetermined length and removably attached to the housing, a transceiver located inside the housing and configured to communicate with a wireless device, and a user control coupled to the housing and configured to activate the device. The device is useful for providing an alert to the user to check for an occupancy of a vehicle before exiting the vehicle.

### CROSS-REFERENCE TO RELATED APPLICATION(S)

The present application is related to and claims priority to U.S. Provisional Patent Application No. 62/472,476 filed Mar. 16, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of alarm systems of existing art and more specifically relates to wearable alert devices.

### RELATED ART

Every year during the summer months a child dies from heatstroke. In spite of the news media, education and awareness these detrimental tragedies continue to occur. Incidents such as these tend to increase whenever there's a change in the caregiver's daily routine This may be especially true if they are not used to dropping the child off or the baby/child falls asleep in the back seat of the car. The daily rush of being on time for work, meeting deadlines, and hectic traffic can cause a caregiver to be distracted. Statistics show that 17% of children are intentionally left in a car by an adult. Many people do not realize that the temperature inside a car can be much higher than the outside temperatures and that it generally takes only about 10 minutes to reach dangerous levels (outside temp 80 degrees, inside a car temp 100 degrees). Infants and children four years and younger are more susceptible to heat related illness because their bodies haven't fully developed to regulate temperature yet. A suitable solution is desired.

U.S. Pat. No. 8,659,414 to Chad Schuk relates to a wireless object-proximity monitoring and alarm system. The described wireless object-proximity monitoring and alarm system includes a separable seat monitor for affixation to the seat's shoulder straps. The seat monitor has a first housing affixable to one of the shoulder straps and a second housing affixable to a second shoulder strap. The second housing has a transceiver for wireless communication and a microcontroller integrated with the transceiver. A micro switch is communicative with the microcontroller and is responsive to the proximity of the first housing. A connecting strap extends between the housings and is separable from at least one housing. A key fob for retention by a child caregiver has a fob case and a transceiver therein for wireless communication with the seat monitor transceiver. A microcontroller is integrated with the transceiver, and an alarm is selectively operable between a first silent sate and a second audible alarm generating state.

### SUMMARY OF THE INVENTION

In view of the foregoing disadvantages inherent in the known alarm system art, the present disclosure provides a novel wearable alert device. The general purpose of the present disclosure, which will be described subsequently in greater detail, is to provide an alert to the user to check for an occupancy of a vehicle before exiting the vehicle.

A device for providing an alert to a user is disclosed herein. The device for providing an alert to a user may include a housing, a display screen attached to the housing and configured to display a plurality of images, a band having a predetermined length and removably attached to the housing, a transceiver located inside the housing and configured to communicate with a wireless device, and a user control coupled to the housing and configured to activate the device. The device may be useful for providing an alert to the user to check for an occupancy of a vehicle before exiting the vehicle.

According to another embodiment, a method of using a device that provides an alert to a user is also disclosed herein. The method of using a device that provides an alert to a user may include providing a device comprising a housing, a display screen display screen attached to the housing, a band having a predetermined length and removably attached to the housing, a transceiver located inside the housing, and a user control coupled to the housing, wearing the device on a wrist of the user, and activating the device by using the user control.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a wearable alert device, constructed and operative according to the teachings of the present disclosure.

FIG. 1 is a perspective view of the wearable alert device during an ‘in-use’ condition, according to an embodiment of the disclosure.

FIG. 2 is a front view of the wearable alert device of FIG. 1, according to an embodiment of the present disclosure.

FIG. 3 is a perspective view of the wearable alert device of FIG. 1, according to an embodiment of the present disclosure.

FIG. 4 is a perspective view of the wearable alert device of FIG. 1, according to an embodiment of the present disclosure.

FIG. 5 is a flow diagram illustrating a method of using the device that provides an alert to a user, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an alarm system and more particularly to a wearable alert device as used to provide an alert to the user to check for an occupancy of a vehicle before exiting the vehicle.

Generally, the present invention may provide users with a safety alarm capable of sounding an alert when a child or pet is left behind in a vehicle. The device may resemble a watch with a built-in alarm, sounding the alert after a specific amount of time and reminding a parent/guardian/user to check the vehicle for children and/or pets. This device may help to eliminate the worry of a child or pet being seriously injured or dying if left behind in a hot or cold vehicle. The device may include a series of images displayed on the watch to function as a visual reminder to check the vehicle. The present invention offers a simple and convenient reminder system to prevent children and pets from being left in the vehicle.

As above, the device may resemble a wristwatch and include a display screen, wireless communication capabilities, and can be paired with a mobile application. The mobile application may allow for the user to configure a set of custom alert settings including timers that may help provide reminders to check the vehicle. Users can preset a time (e.g., 30 minutes) for the alarm to sound. After the timeframe has passed, the watch will provide a highly-audible alert, reminding the user to check the vehicle for children and/or pets. The reminders and alerts may be both audible and visual, ensuring that the reminder is noticed.

The device can be constructed using plastic or silicone, leather, stainless steel and other flexible materials. An on/off indicator may be included for operation. The device may be available in various sizes in order to accommodate all user needs and preferences. Exact size, measurement, construction, and design specifications may vary upon manufacturing.

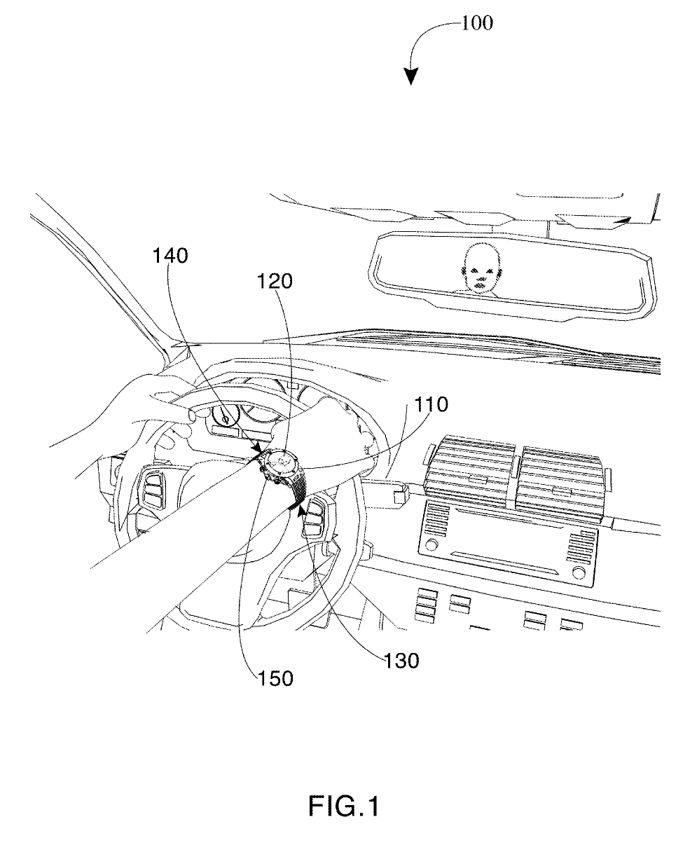

Referring now more specifically to the drawings by numerals of reference, there is shown in FIGS. 1-4, various views of a device 100 for providing an alert to a user.

FIG. 1 shows a device 100 for providing an alert to a user during an ‘in-use’ condition 50, according to an embodiment of the present disclosure. Here, the device 100 for providing an alert to a user 40 may be beneficial for use by a user 40 to provide an alert to the user 40 to check for an occupancy of a vehicle before exiting the vehicle. As illustrated, the device 100 may include a housing 110, a display screen 120 attached to the housing and configured to display a plurality of images, and a band 130 having a predetermined length and removably attached to the housing. The device 100 may also have a transceiver 140 located inside the housing and a user control 150 coupled to the housing and configured to activate the device.

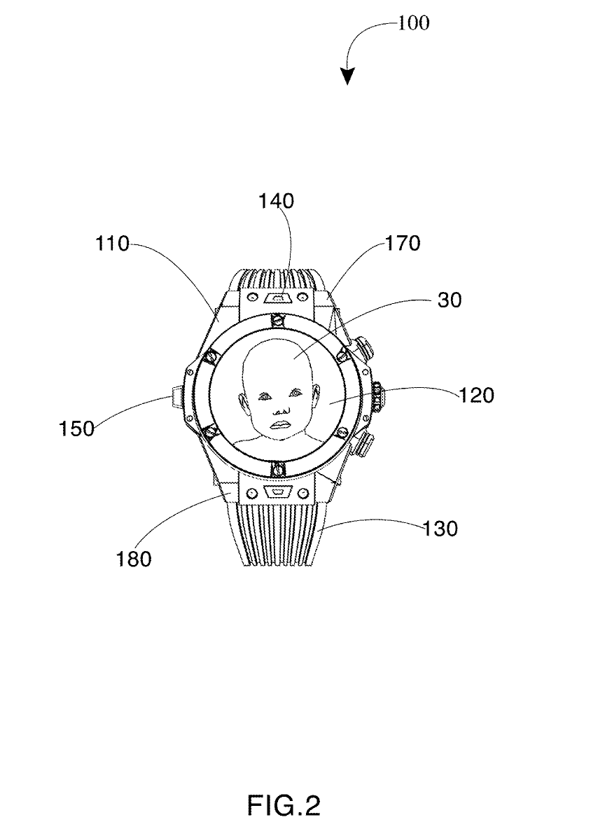

Referring now to FIG. 2 showing the device 100 for providing an alert to a user 40 of FIG. 1, according to an embodiment of the present disclosure. As above, the device 100 may include a housing 110 having a first side 170 and a second side 180, a display screen 120 attached to the housing, and a band 130 removably attached to the housing. The device 100 may also feature a transceiver 140 located inside the housing and a user control 150 configured to activate the device. The display screen 120 may feature a plurality of images. One of such images may include a face of a baby 30 to help serve as a reminder that the vehicle may be occupied.

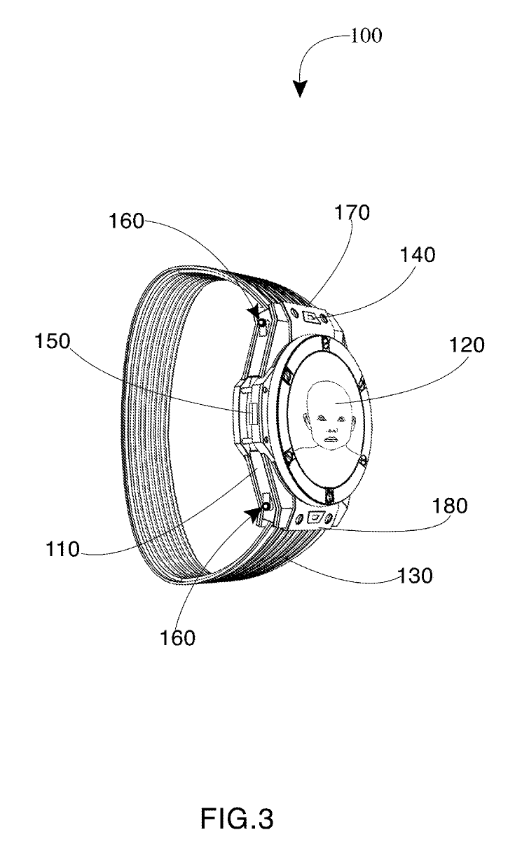

FIG. 3 is a perspective view of the device 100 for providing an alert to a user 40 of FIG. 1, according to an embodiment of the present disclosure. Here again, the device 100 may include a housing 110 having a first side 170 and a second side 180, a display screen 120 attached to the housing, and a band 130 removably attached to the housing. The device 100 may also feature a transceiver 140 located inside the housing and a user control 150 configured to activate the device. The first side 170 and second side 180 of the device 100 may include a plurality of fasteners 160, wherein one of the plurality of fasteners 160 may be featured on each of the first side 170 and second side 180. The fasteners 160 may be useful for removably attaching the band 130 to the housing 110.

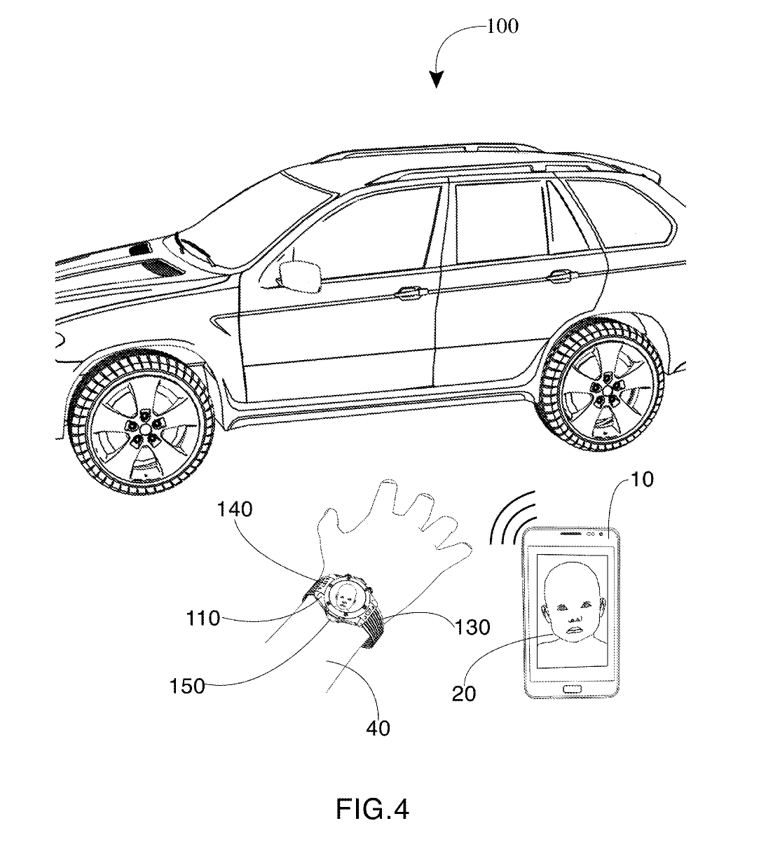

Referring now to FIG. 4 is a perspective view of the device 100 for providing an alert to a user 40 of FIG. 1, according to an embodiment of the present disclosure. As above, the device 100 for providing an alert to a user 40 may include a housing 110, a band 130 removably attached to the housing, a transceiver 140 located inside the housing and configured to communicate with a wireless device 10, and a user control 150 coupled to the housing 110 and configured to activate the device 100. The wireless device 10 may have a mobile application 20 that can be used to select and update settings or other user preferences.

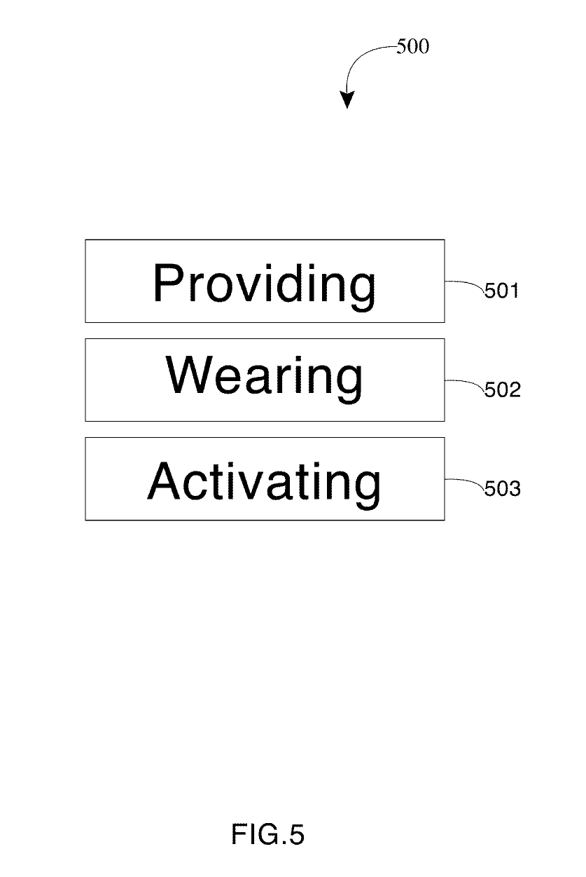

FIG. 5 is a flow diagram illustrating a method of using 500 a device 100 that provides an alert to a user 40, according to an embodiment of the present disclosure. In particular, the method of use 500 may include one or more components or features of the device 100 for providing an alert to a user as described above. As illustrated, the method of using 500 may include the steps of: step one 501, providing a device comprising a housing, a display screen wherein the display screen is attached to the housing, a band having a predetermined length and removably attached to the housing, a transceiver located inside the housing, and a user control coupled to the housing; step two 502, wearing the device on a wrist of the user; and step three 503, activating the device by using the user control.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a device that provides an alert to a user are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for providing an alert to a user, the device comprising:
a housing;
a display screen, the display screen attached to the housing and configured to display a plurality of images;
a band, the band having a predetermined length and removably attached to the housing;
a transceiver, the transceiver located inside the housing and configured to communicate with a wireless device;
a user control, the user control coupled to the housing and configured to activate the device; and
wherein the device is configured to provide an alert to the user to check an occupancy of a vehicle before exiting the vehicle.

2. The device of claim 1, wherein the device is wearable.

3. The device of claim 2, wherein the device is a wristwatch.

4. The device of claim 1, wherein the housing is disk-shaped.

5. The device of claim 1, wherein the band is flexible.

6. The device of claim 5, wherein the band comprises of plastic.

7. The device of claim 1, wherein the wireless device has a mobile application.

8. The device of claim 1, further comprising a plurality of fasteners coupled to the housing.

9. The device of claim 8, wherein one of the plurality of fasteners is located on a first side of the housing.

10. The device of claim 9, wherein a second of the plurality of fasteners is located on a second side of the housing.

11. The device of claim 8, wherein the plurality of fasteners is configured to removably attach the band to the housing.

12. The device of claim 1, wherein the device is configured to receive a plurality of notifications from the wireless device.

13. The device of claim 12, wherein the plurality of notifications include audible and visual alerts.

14. The device of claim 1, wherein the user control is an on/off indicator.

15. The device of claim 1, wherein the one of the plurality of images includes an image of a face of a baby.

16. The device of claim 7, wherein the mobile application allows the user to select a predetermined time for the alert to notify the user.

17. A device for providing an alert to a user, the device comprising:
a housing;
a display screen, the display screen attached to the housing and configured to display a plurality of images;
a band, the band having a predetermined length and removably attached to the housing;
a transceiver, the transceiver located inside the housing and configured to communicate with a wireless device;
a user control, the user control coupled to the housing and configured to activate the device;
wherein the device is wearable;
wherein the device is a wristwatch;
wherein the housing is disk-shaped;
wherein the band is flexible;
wherein the band comprises plastic;
wherein the wireless device has a mobile application;
further comprising a plurality of fasteners coupled to the housing;
wherein one of the plurality of fasteners is located on a first side of the housing;
wherein a second of the plurality of fasteners is located on a second side of the housing;
wherein the plurality of fasteners is configured to removably attach the band to the housing;
wherein the device is configured to receive a plurality of notifications from the wireless device;
wherein the plurality of notifications include audible and visual alerts;
wherein the user control is an on/off indicator;
wherein the one of the plurality of images includes an image of a face of a baby;
wherein the mobile application allows the user to select a predetermined time for the alert to notify the user; and
wherein the device is configured to provide an alert to the user to check an occupancy of a vehicle before exiting the vehicle.

18. A method of using a device that provides an alert to a user, comprising:
providing a device comprising a housing; a display screen, the display screen attached to the housing; a band, the band having a predetermined length and removably attached to the housing; and a transceiver, the transceiver located inside the housing; a user control, the user control coupled to the housing;
wearing the device on a wrist of the user;
activating the device by using the user control; and
wherein the device communicates with a wireless device.

19. The method of claim 18, wherein the display screen displays a plurality of images.

20. The method of claim 18, wherein the device alerts the user to check an occupancy of a vehicle before exiting the vehicle.
